(19) United States
(12) Patent Application Publication
(10) Pub. No.: US 2019/0292060 A1
(43) Pub. Date: Sep. 26, 2019

(54) COPPER PLATED CARBON POWDERS FOR COPPER-CARBON COMPOSITE FABRICATION

(71) Applicant: GM Global Technology Operations LLC, Detroit, MI (US)

(72) Inventor: Hongliang Wang, Sterling Heights, MI (US)

(21) Appl. No.: 15/933,567

(22) Filed: Mar. 23, 2018

(51) Int. Cl. C01B 32/372; B22F 1/00

(52) U.S. Cl. CPC C01B 32/372; B22F 1/0051; B22F 2304/10; C01B 2204/32; B22F 2303/40; B22F 2301/10; B22F 2302/40

(57) ABSTRACT

A copper-carbon composite forming mixture includes multiple carbon particles each plated with copper. The carbon particles prior to plating have an average size ranging between approximately 0.5 microns to 500 microns. Multiple copper particles are combined with the multiple carbon particles plated with copper to form a mixture. The mixture is either pre-heated prior to extrusion or extruded at ambient temperature to form a copper-carbon composite having a conductivity greater than a conductivity of copper at temperatures approximately 500 degrees Kelvin.

### GOVERNMENT FUNDING

The U.S. Government has a paid-up license in this invention and the right in limited circumstances to require the patent owner to license others on reasonable terms as provided for by the terms of D.O.E. contract no. GR-PNNL TCF 382-DPN awarded by Pacific Northwest National Laboratory (PNNL).

### INTRODUCTION

The present disclosure relates to improvements of material conductivity of copper material through the incorporation of carbon in a variety of formations, including but not limited to carbon nanotubes, graphite or graphene, with copper.

Increased portability, versatility and ubiquity of electronics devices and electrical conductors may result from miniaturization which requires current flow through a narrower cross section. Present electrical conductors operate close to a maximum current carrying capacity or ampacity of the conductive material such as copper, which may lead to a decreased lifetime and performance. Ampacity represents a maximum current carrying capacity of the object which depends on both the structure and the material.

To improve the ampacity of copper, it is known to create composite materials including carbon nanotubes coated or embedded with copper. Such known composites grow the carbon nanotubes, which limits their applications to microscale electronics and inverters. Although such carbon nanotube copper composite materials exhibit approximately 100 times higher ampacity as copper (6×10⁸ A cm⁻²), the growth rate and size of structures available using such nanotubes is not scalable to industrial applications, such as for use as conductors or windings in electrical motors. The working temperature of electric motors is approximately 200 degrees Centigrade, therefore, a carbon nanotube copper composite material must be capable of working at this temperature for extended periods of time with improved energy efficiency and decreased heat generation due to its internal resistance.

Thus, while current carbon nanotube copper composite materials achieve their intended purpose, there is a need for a new and improved system and method for plating carbon material with copper to improve the ampacity and conductivity of the copper.

### SUMMARY

According to several aspects, a copper-carbon composite forming mixture includes multiple carbon particles plated with copper. Multiple copper particles are combined with the multiple carbon particles plated with copper to form the mixture.

According to several aspects, a finished member processed by extruding the mixture defines a copper-carbon composite having a conductivity greater than a conductivity of copper at temperatures above approximately 350 degrees Kelvin.

According to several aspects, the finished member is processed using a shear assisted processing and extrusion (ShAPE) operation extruding the mixture through a spinning die, the spinning die including an end face having a raised spiral frictionally contacting the mixture and forcing the mixture through a die bore to form a copper-carbon composite.

According to several aspects, the finished member is processed using a shear assisted processing and extrusion (ShAPE) operation including heating the mixture prior to extruding the mixture through a spinning die, the spinning die including an end face having a raised spiral frictionally contacting the mixture and forcing the mixture through a die bore to form a copper-carbon composite.

According to several aspects, the finished member is processed by extruding the mixture using: an extrusion press including a press container having a cavity receiving the mixture; and a die fixed in position to the press container, the die including a die opening having a predetermined geometric shape to produce the finished member with a desired shape.

According to several aspects, the mixture is heated prior to extrusion through the die opening to create the finished member.

According to several aspects, the carbon particles are plated using an electroless plating process prior to mixing with the copper particles.

According to several aspects, the carbon particles prior to plating have an average size ranging between approximately 0.5 microns to 500 microns; and a copper plating layer created on the carbon particles has a thickness ranging between approximately 0.1 microns to 20 microns.

According to several aspects, a carbon content of the mixture compared to copper ranges from approximately 5% to approximately 30% by weight.

According to several aspects, a carbon content of the mixture is selected to double the conductivity of the finished member compared to a conductivity of copper when the temperature is approximately 500 degrees Kelvin.

According to several aspects, a copper-carbon composite forming mixture includes multiple carbon particles each plated with copper, the carbon particles prior to plating have an average size ranging between approximately 0.5 microns to 500 microns; and multiple copper particles combined with the multiple carbon particles plated with copper to form a mixture, the mixture when consolidated and extruded forming a copper-carbon composite having a conductivity greater than a conductivity of copper at temperatures above approximately 350 degrees Kelvin.

According to several aspects, a carbon content of the mixture compared to copper ranges from approximately 5% to approximately 30% by weight.

According to several aspects, a carbon content of the mixture compared to copper ranges between approximately 0.5% to approximately 50% by weight.

According to several aspects, the mixture is substantially at an ambient temperature prior to extruding the mixture.

According to several aspects, the mixture is preheated to at least partially soften the copper of the carbon particles each plated with copper and the copper particles prior to extruding the mixture.

According to several aspects, a carbon content of the mixture is selected to substantially double the conductivity of the copper-carbon composite compared to a conductivity of copper when the temperature of the copper-carbon composite is approximately 500 degrees Kelvin.

According to several aspects, extrusion to form the copper-carbon composite applies a shear assisted processing and extrusion (ShAPE) operation and includes extruding the mixture through a spinning die.

According to several aspects, a method for creating a copper-carbon composite comprises the steps of: plating multiple carbon particles with copper; creating a mixture containing the plated carbon particles and multiple copper particles; and processing a finished member by extruding the mixture, the finished member defining a copper-carbon composite having a conductivity greater than a conductivity of copper at temperatures above approximately 350 degrees Kelvin.

According to several aspects, the processing step includes using a shear assisted processing and extrusion (ShAPE) operation including either pre-heating the mixture prior to extruding the mixture through a spinning die or extruding the mixture at ambient temperature through the spinning die.

According to several aspects, the processing step includes: fixing a die to a press container of an extrusion press, the die having a die opening having a predetermined geometric shape to produce the finished member; loading the mixture in a cavity of the press container; and pressing the mixture through the die.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic presentation of a first method to produce a composite of copper plated carbon particles and un-plated copper particles processed using a shear assisted processing and extrusion (ShAPE) operation;

FIG. 2 is an end perspective view of a spinning die used in the ShAPE operation of FIG. 1;

FIG. 3 is a cross sectional front elevational view of an extrusion die used to extrude a composite of copper plated carbon particles and un-plated copper particles of the present disclosure; and

FIG. 4 is a graph depicting conductivity versus temperature for copper compared to a composite.

### DETAILED DESCRIPTION

The following description is merely exemplary in nature and is not intended to limit the present disclosure, application, or uses.

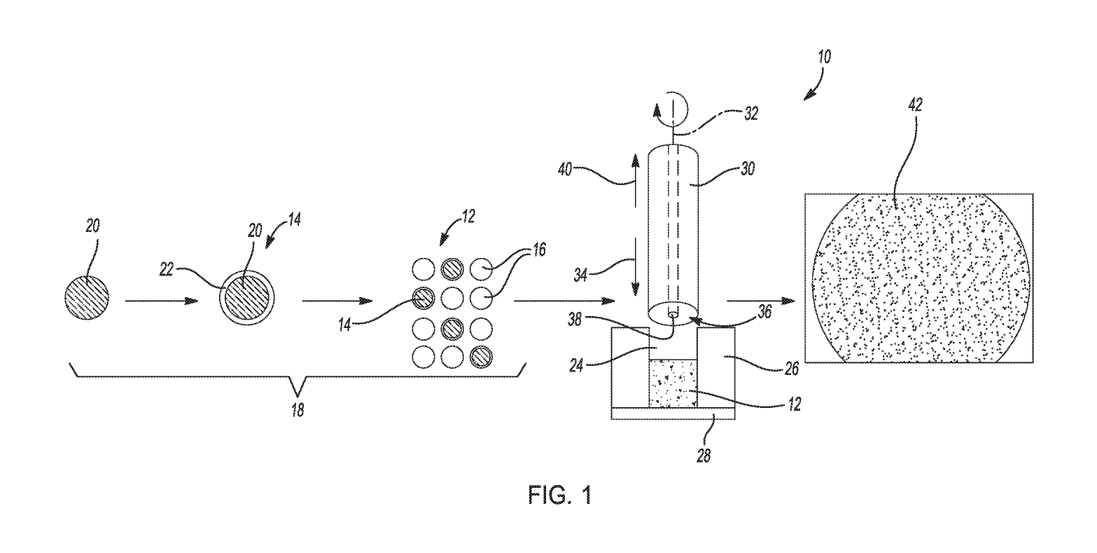

Referring to FIG. 1, a first process and method of manufacturing a composite material having particles of carbon in a variety of formations, such as nanotubes, graphite and graphene, and the like, hereinafter for simplicity collectively referred to as “carbon” particles as carbon is the basic material of nanotubes, graphite and graphene, together with particles or billets of copper is depicted. The first method uses a shear assisted processing and extrusion (ShAPE) operation to process a mixture 12 containing copper plated carbon particles 14 and un-plated copper particles 16. Initially, as shown in steps 18, multiple carbon particles 20 which may for example individually have an average size of approximately 10 to 50 microns prior to plating are plated with copper. According to further aspects, the multiple carbon particles 20 can individually have a broader range of sizes, with an average size of approximately 0.5 to 500 microns prior to plating with copper.

The carbon particles 20 are copper plated using either an electroless plating process, a non-galvanic plating method that involves several simultaneous reactions in an aqueous solution which occur without the use of external electrical power, or using an electro-plating process providing a copper plating 22 layer to form multiple ones of the copper plated carbon particles 14. According to several aspects, the copper plating 22 layer may for example have a thickness of approximately 1 to 5 microns, and according to several aspects can more broadly have a thickness ranging from approximately 0.1 to 20 microns, but can vary in thickness depending on the carbon particle size and the total volume of copper and carbon desired in the mixture 12. The copper plated carbon particles 14 are then batch mixed with multiple ones of the copper particles 16 to produce the mixture 12. The mixture 12 may include a total amount of carbon by volume ranging from approximately 5% to approximately 30% by weight compared to the volume of copper, although these quantities can vary above or below these percentages depending on the material (carbon, nanotubes, graphite, graphene, or the like) which is used. For example, according to further aspects, the mixture 12 may include a total amount of carbon by volume ranging from approximately 0.5% to approximately 50% compared to the volume of copper.

For the ShAPE operation the mixture 12 containing both the copper plated carbon particles 14 and the copper particles 16 is then loaded into a cavity 24 of a press container 26. The mixture 12 can be loaded in a non-preheated condition (generally at ambient temperature), or a heating plate 28 may be optionally provided to preheat and soften the mixture 12 after loading. A spinning die 30 which axially rotates at high speed about an axis of rotation 32 is forced under pressure in a first direction 34 into the press container 26 until a die end face 36 directly contacts the mixture 12. Heat is initially generated by friction between the various copper plated carbon particles 14 and the copper particles 16 of the mixture 12 as the spinning die end face 36 contacts the particles of the mixture 12, in addition to the pressure applied by the die end face 36 in the first direction 34.

As the powder or mixture 12 consolidates additional heat is generated by dissipation of plastic work energy. The energy released from plastic work results in significant heating, from approximately 700 degrees Centigrade to approximately 900 degrees Centigrade. The heat and strain energy imparted to the material of the mixture 12 causes the particles to fully densify and creates plastic flow in a complex way dictated by the design and features on the die end face 36. During plastic flow the mixture is in a state of continuous dynamic recrystallization, which results in a wide range of microstructures, and final grain sizes depend on cooling rates and chemistry. Very high levels of total strain produce good mixing of the constituents of the mixture 12 and diffusion rates high enough for good oxide mobility or dissolution and redistribution to form nano-clusters.

The softened or plastic flowing material of the mixture 12 is then forced to extrude through a port, or die passage 38 under pressure in a second direction 40 opposite to the first direction 34. A tube or strand 42 of a composite of carbon and copper materials exits the die passage 38 and cools. The strand 42 typically has a circular cross section whose diameter can vary depending on the sizes of the die end face 36 and the die passage 38. The strand 42 defines a finished member of a copper-carbon composite having a conductivity greater than a conductivity of copper at temperatures above approximately 350 degrees Kelvin.

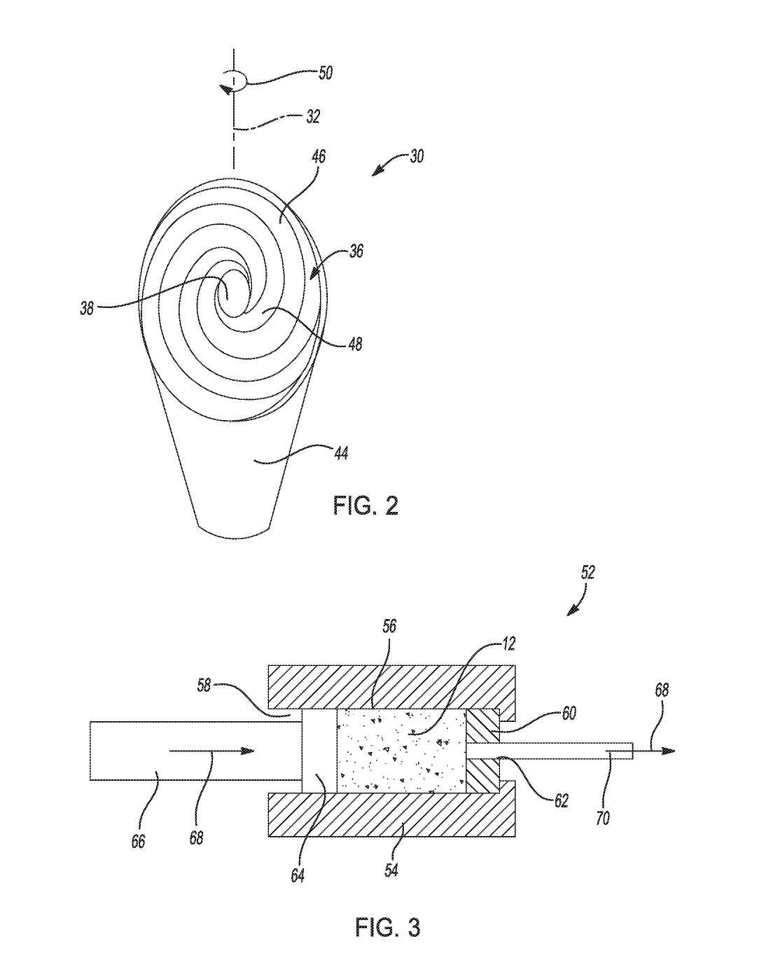

Referring to FIG. 2 and again to FIG. 1, the die 30 used in the ShAPE process described in reference to FIG. 1 includes a tubular body 44. The die end face 36 has at least one raised spiral 46. The die 30 is rotated about the axis of rotation 32 at high speed with the die end face 36 and the raised spiral 46 directly contacting the material of the mixture 12 which is retained in the press container 26. The spiral direction of the raised spiral 46 creates one or more spiral-shaped passages 48 that direct the softened or plastic material into the die passage 38 where it back extrudes the consolidated carbon and copper material.

Referring to FIG. 3 and again to FIGS. 1 and 2, a second process for extruding the mixture 12 is depicted. An extrusion press 52 includes a press container 54 having a cavity 56 which receives the mixture 12, for example by end loading the mixture 12 through an opening 58. A die 60 is fixed in position at one end of the press container 54. The die 60 provides a die opening 62 having a predetermined geometric shape, the die opening 62 communicating with the press container 54. The mixture 12 can be loaded in a non-preheated condition (generally the ambient temperature), pre-heated prior to loading, or the press container 54 containing the mixture 12 may be heated after the mixture 12 is loaded into the press container 54 to soften the mixture 12.

After the mixture 12 is in place in the cavity 56, a press disc 64 is slidably positioned in the cavity 56 in contact with the mixture 12. A press ram 66 is brought into direct contact with the press disc 64 and displaced in the cavity 56 together with the press disc 64 in an extrusion direction. 68. As the press ram 66 is displaced, the material of the mixture 12 consolidates as it is forced through the die opening 62 to create an elongated strand 70. Similar to the strand 42, the strand 70 defines a finished member processed by extruding the mixture 12, the finished member defining a copper-carbon composite having a conductivity greater than a conductivity of copper at temperatures above approximately 350 degrees Kelvin.

For the second process described in reference to FIG. 3, the material of the mixture 12 can be cold extruded (extruded from ambient temperature material of the mixture 12), or softened in several ways prior to extrusion. The material of the mixture 12 can be preheated to consolidate the material, or preheated to at least partially soften and consolidate the material prior to loading into the cavity 56 and immediately extruded. Alternately, the material of the mixture 12 in mixed powder form or having copper billets (solid pieces of copper) mixed with the copper plated carbon particles 14 can be loaded into the press container 54. The press container 54 may then be heated to soften and consolidate the composite material contained therein for extrusion. The opening 58 of the die 60 can have any desired geometric form, including circular, oval, square, rectangular, and others. This permits the elongated strand 70 to be formed having any desired geometric cross sectional shape.

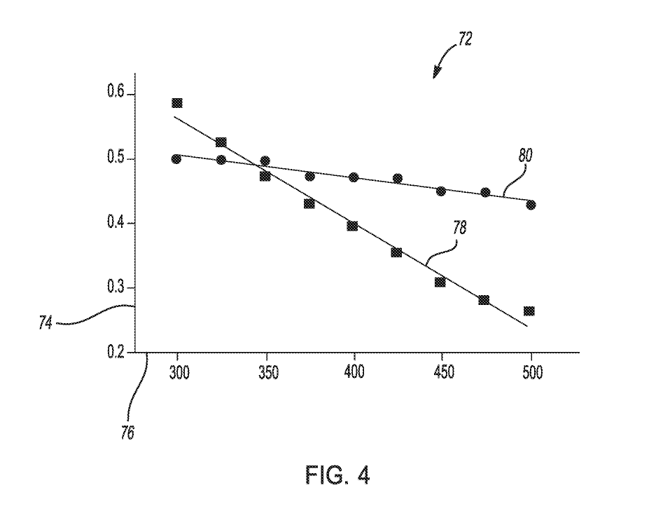

Referring to FIG. 4, a graph 72 provides a range of conductivity values 74 (×10⁶ Siemens per cm⁻¹) over a range of temperatures 76 (Kelvin). The conductivity defines a measure of an ability of a substance to conduct electric current, which is also equal to a reciprocal of a resistivity of the substance. A first curve 78 identifies conductivity steadily decreases as temperature increases up to 500 degrees Kelvin for copper material, indicating the susceptibility of copper to decreasing conductivity and therefore increasing resistivity as the temperature reaches the working temperatures of electric motors for example. This increasing resistivity is undesirable for applications such as electrical motors which operate at higher working temperatures due to power/efficiency loss and heat buildup.

A second curve 80 represents a measured conductivity over the same temperature range for exemplary small scale nanotubes made using the materials of the present disclosure. The conductivity of a finished member, when heated and consolidated, which includes a percentage of carbon with copper, is approximately 0.47×10⁶ S cm⁻¹ at 500 degrees K and indicates significantly reduced effect from increasing temperature compared to the lower conductivity of copper alone at 500 degrees K, which is approximately 0.29×10⁶ S cm⁻¹. The graph 72 indicates the finished member defines a copper-carbon composite having a conductivity greater than a conductivity of copper at temperatures above approximately 350 degrees Kelvin, and increases significantly as the temperature approaches 500 degrees Kelvin.

A copper-carbon composite forming mixture of the present disclosure offers several advantages. These include a mixture having multiple carbon particles plated with copper; and multiple copper particles combined with the multiple carbon particles plated with copper. The mixture when processed such as by extrusion produces a copper-carbon composite having a conductivity greater than a conductivity of copper at temperatures above approximately 350 degrees Kelvin. A carbon content of the mixture can be selected to double the conductivity of the copper-carbon composite compared to a conductivity of copper when the temperature is approximately 500 degrees Kelvin.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A copper-carbon composite forming mixture, comprising:
multiple carbon particles plated with copper; and
multiple copper particles combined with the multiple carbon particles plated with copper to form a mixture.

2. The copper-carbon composite forming mixture of claim 1, wherein a finished member processed by extruding the mixture defines a copper-carbon composite having a conductivity greater than a conductivity of copper at temperatures above approximately 350 degrees Kelvin.

3. The copper-carbon composite forming mixture of claim 2, wherein the finished member is processed using a shear assisted processing and extrusion (ShAPE) operation extruding the mixture through a spinning die, the spinning die including an end face having a raised spiral frictionally contacting the mixture and forcing the mixture through a die bore to form a copper-carbon composite.

4. The copper-carbon composite forming mixture of claim 2, wherein the finished member is processed using a shear assisted processing and extrusion (ShAPE) operation including heating the mixture prior to extruding the mixture through a spinning die, the spinning die including an end face having a raised spiral frictionally contacting the mixture and forcing the mixture through a die bore to form a copper-carbon composite.

5. The copper-carbon composite forming mixture of claim 2, wherein the finished member is processed by extruding the mixture using:
an extrusion press including a press container having a cavity receiving the mixture; and
a die fixed in position to the press container, the die including a die opening having a predetermined geometric shape to produce the finished member with a desired shape.

6. The copper-carbon composite forming mixture of claim 5, wherein the mixture is heated prior to extrusion through the die opening to create the finished member.

7. The copper-carbon composite forming mixture of claim 1, wherein the carbon particles are plated using an electroless plating process prior to mixing with the copper particles.

8. The copper-carbon composite forming mixture of claim 1, wherein:
the carbon particles prior to plating have an average size ranging between approximately 0.5 microns to 500 microns; and
a copper plating layer created on the carbon particles has a thickness ranging between approximately 0.1 microns to 20 microns.

9. The copper-carbon composite forming mixture of claim 1, wherein a carbon content of the mixture compared to copper ranges from approximately 5% to approximately 30% by weight.

10. The copper-carbon composite forming mixture of claim 2, wherein a carbon content of the mixture is selected to double the conductivity of the finished member compared to a conductivity of copper when the temperature is approximately 500 degrees Kelvin.

11. A copper-carbon composite forming mixture, comprising:
multiple carbon particles each plated with copper, the carbon particles prior to plating have an average size ranging between approximately 0.5 microns to 500 microns; and
multiple copper particles combined with the multiple carbon particles plated with copper to form a mixture, the mixture when consolidated and extruded forming a copper-carbon composite having a conductivity greater than a conductivity of copper at temperatures above approximately 350 degrees Kelvin.

12. The copper-carbon composite forming mixture of claim 11, wherein a carbon content of the mixture compared to copper ranges from approximately 5% to approximately 30% by weight.

13. The copper-carbon composite forming mixture of claim 11, wherein a carbon content of the mixture compared to copper ranges between approximately 0.5% to approximately 50% by weight.

14. The copper-carbon composite forming mixture of claim 11, wherein the mixture is substantially at an ambient temperature prior to extruding the mixture.

15. The copper-carbon composite forming mixture of claim 11, wherein the mixture is preheated to at least partially soften the copper of the carbon particles each plated with copper and the copper particles prior to extruding the mixture.

16. The copper-carbon composite forming mixture of claim 11, wherein a carbon content of the mixture is selected to substantially double the conductivity of the copper-carbon composite compared to a conductivity of copper when the temperature of the copper-carbon composite is approximately 500 degrees Kelvin.

17. The copper-carbon composite forming mixture of claim 11, wherein extrusion to form the copper-carbon composite applies a shear assisted processing and extrusion (ShAPE) operation and includes extruding the mixture through a spinning die.

18. A method for creating a copper-carbon composite, comprising the steps of:
plating multiple carbon particles with copper;
creating a mixture containing the plated carbon particles and multiple copper particles; and
processing a finished member by extruding the mixture, the finished member defining a copper-carbon composite having a conductivity greater than a conductivity of copper at temperatures above approximately 350 degrees Kelvin.

19. The method for creating a copper-carbon composite of claim 18, wherein the processing step includes using a shear assisted processing and extrusion (ShAPE) operation including either pre-heating the mixture prior to extruding the mixture through a spinning die or extruding the mixture at ambient temperature through the spinning die.

20. The method for creating a copper-carbon composite of claim 18, wherein the processing step includes:
fixing a die to a press container of an extrusion press, the die having a die opening having a predetermined geometric shape to produce the finished member;
loading the mixture in a cavity of the press container; and
pressing the mixture through the die.
